(19) United States
(12) Patent Application Publication
(10) Pub. No.: US 2014/0243068 A1
(43) Pub. Date: Aug. 28, 2014

(54) MULTIPLAYER SLOTS GAME AND METHOD OF OPERATION

(71) Applicant: DELTA TWO HOLDINGS, LLC, Las Vegas, NV (US)

(72) Inventors: John E. Cibulski, Los Angeles, CA (US); Michael Marchetti, Manhattan Beach, CA (US)

(73) Assignee: DELTA TWO HOLDINGS, LLC, Las Vegas, NV (US)

(21) Appl. No.: 13/781,415

(22) Filed: Feb. 28, 2013

(51) Int. Cl. G07F 17/32

(52) U.S. Cl. CPC G07F 17/3276
USPC 463/20

(57) ABSTRACT

A multiplayer slots game system comprising a multiplayer slots game controller operating on a processor. A plurality of multiplayer slots interfaces, each operating on an associated processor and coupled to the multiplayer slots game controller through a communications medium. A plurality of user interfaces operating on each of the multiplayer slots interfaces, each of the plurality of user interfaces generating a user display that includes two or more user identifiers.

### TECHNICAL FIELD

The present disclosure relates to gaming, and more specifically to a multiplayer slots game and method of operation that allows multiple players to participate and compete at slots.

### BACKGROUND OF THE INVENTION

Slot machine games, or “slots,” were originally mechanical gaming devices that utilized separate wheels having predetermined symbols displayed around the perimeter. The slot machines included a lever, which a player would pull in order to activate the gaming action. The player would win various amounts when predetermined combinations of symbols appeared in a line at a predetermined location. Such games were thus intrinsically single player games.

### SUMMARY OF THE INVENTION

A multiplayer slots game system is provided, such as to allow two or more players to competitively participate in a slots game. In one exemplary embodiment, the multiplayer slots game includes a multiplayer slots game controller operating on a processor, such as a centralized game server. A plurality of multiplayer slots interfaces, such as may be implemented in conjunction with a web browser and each operating on an associated processor, are connected to the multiplayer slots game controller through a communications medium, such as the Internet. A plurality of user interfaces operating on each of the multiplayer slots interfaces, such as user interface screens within the web browser, each generate a user display that includes two or more user identifiers, to allow a user to see pictures or “avatars” of other players that are participating in the multiplayer slots game, such as in a gaming environment that is implemented as a plurality of rooms, where each user is assigned to one of the rooms.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a user interface for a multiplayer slots game in accordance with an exemplary embodiment of the present disclosure;

FIG. 2 is a diagram of an algorithm for controlling a multiplayer slots game in accordance with an exemplary embodiment of the present disclosure;

FIG. 3 is a diagram of an algorithm for controlling multiplayer action of a slots game in accordance with an exemplary embodiment of the present disclosure; and

FIG. 4 is a diagram of a system for a multiplayer slot machine gaming environment in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

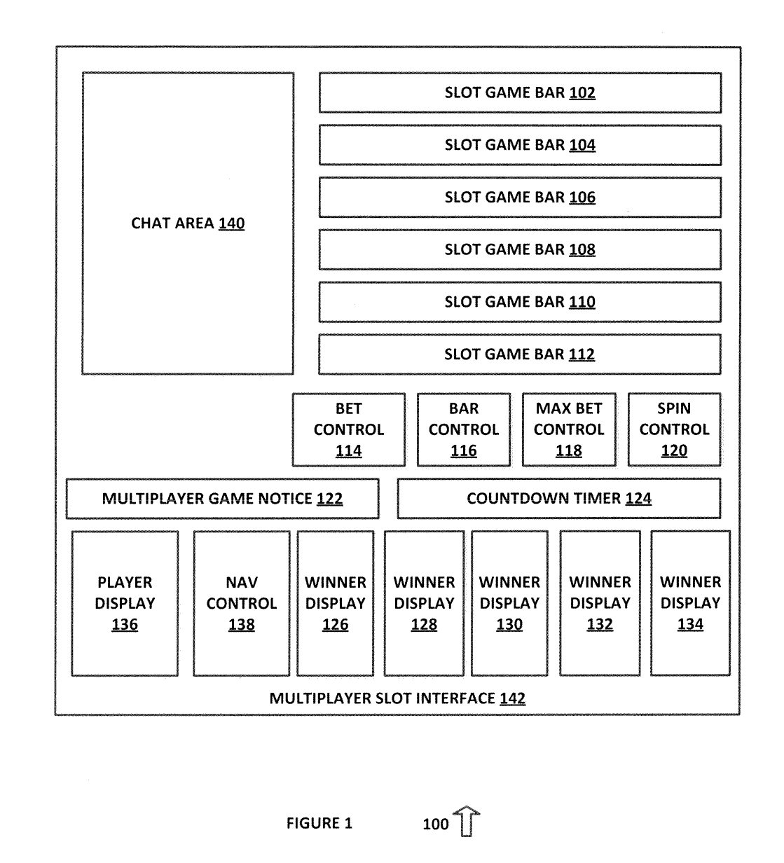

FIG. 1 is a diagram of a user interface 100 for a multiplayer slots game in accordance with an exemplary embodiment of the present disclosure. User interface 100 can be generated using hardware or a suitable combination of hardware and software, and can be an interactive control on a display apparatus of a suitable platform, such as a personal computer, a lap top computer, a cellular telephone with a keyboard or touch screen interface, a tablet computer with a keyboard or touchscreen interface, or other suitable devices.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes a microcomputer or other suitable controller, memory devices, input-output devices, displays, data input devices such as keyboards or mouses, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

User interface 100 includes multiplayer slots interface 142, which can be a graphic user interface on a suitable computing device or other suitable user interfaces. Multiplayer slots interface 142 can receive user commands from a keyboard, by allowing user selection of predetermined control features using a mouse or other pointing device, by using a touch screen interface, by using voice commands, or in other suitable manners. Multiplayer slots interface 142 includes display features and control features, each of which can be implemented as one or more objects having associated data, graphical and functional characteristics.

Multiplayer slots interface 142 includes slots game bars 102 through 112. Although six slots game bars 102 through 112 are shown, a suitable number of slots game bars can be provided, such as where the number of slots game bars displayed on multiplayer slots interface 142 varies as a function of the number of slots game bars selected by a user. Each slots game bar 102 through 112 can be implemented as a separate object having associated data, graphical and functional attributes, the slots game bars 102 through 112 can be implemented as a single object having data, graphical and functional attributes, or other suitable programming conventions can be used to generate slots game bars 102 through 112.

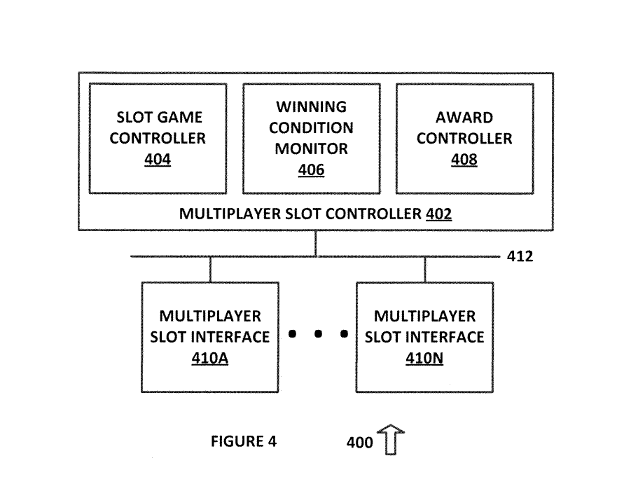

Each slots game bar 102 through 112 displays a predetermined or variable number of icons (e.g. pets, coins, gems, geometric shapes, fruits, seasonal images, card symbols, celebrity likenesses, famous landmarks, trademarks, or other suitable icons), where the combination of icons is dynamically determined after the start of each activation of spin control 120 by a user. In one exemplary embodiment, five icons are randomly selected after activation of spin control 120 by a user, such as by accessing multiplayer slots controller 402 of FIG. 4. In this exemplary embodiment, prize amounts can be associated with one or more combinations of icons, such as to provide different award amounts as a function of the displayed icons. Likewise, credits for additional game play, in-game awards or other suitable prizes can be associated with one or more predetermined icons. Multiplayer slots controller 402 can randomly generate the icons for each slots game bar 102 through 112 after activation of spin control 120, such as by generating a random number that is associated with a predetermined combination of icons, a predetermined prize, or in other suitable manners. For example, the odds of winning a prize can be selected to result in a net profit to the operator of the multiplayer slots game, such as where prize amounts are paid in cash. Likewise, the odds of winning a prize can be based on game metadata, such as for games where players accumulate points in order to buy collection items, to acquire experience points to access additional gaming rooms, or in other suitable manners.

Bet control 114 allows a user to select the amount of game credits that are to be wagered for each activation of spin control 120, for each slots game bar, or in other suitable manners. In one exemplary embodiment, bet control 114 can be implemented as an object having associated data, graphical and functional attributes. Bet control 114 is configured to allow a user to increase or decrease a displayed number of game credits, such as by selecting a user control of bet control 114 using a mouse or other pointer device, by touching a corresponding touch screen control associated with bet control 114, by using a voice recognition system interface, or in other suitable manners.

Bar control 116 allows a user to select the number of slot machine bars that are to be played for each activation of spin control 120. In one exemplary embodiment, bar control 116 can be implemented as an object having associated data, graphical and functional attributes. Bar control 116 is configured to allow a user to increase or decrease a displayed number of game bars, such as by selecting a user control of bar control 116 using a mouse or other pointer device, by touching a corresponding touch screen control associated with bar control 116, by using a voice recognition system interface, or in other suitable manners. For example, bar control 116 can allow a user to select a single bar of five randomly selected icons for each activation of spin control 120, the maximum number of bars that can be displayed for each activation of spin control 120 (six in the embodiment shown in FIG. 1), or a suitable number of bars between the maximum and minimum number.

Max bet control 118 allows a user to select the maximum amount to wager for the next activation of spin control 120. In one exemplary embodiment, max bet control 118 can be implemented as an object having associated data, graphical and functional attributes. Max bet control 118 is configured to allow a user to quickly select the maximum number of game credits that can be wagered without having to increment the amount shown in bet control 114 by using a mouse or other pointer device, by touching a corresponding touch screen control associated with max bet control 118, by using a voice recognition system interface, or in other suitable manners.

Spin control 120 allows a user to initiate one round of gaming action for the slot machine game of user interface 100. In one exemplary embodiment, spin control 120 can be implemented as an object having associated data, graphical and functional attributes. Spin control 120 is configured to allow a user to initiate one round of gaming action by selecting a user control of spin control 120 using a mouse or other pointer device, by touching a corresponding touch screen control associated with spin control 120, by using a voice recognition system interface, or in other suitable manners. In this manner, each player in the gaming room can initiate a round of gaming action independently from other users in the gaming room.

Multiplayer game notice 122 generates notification data to alert players within the game room of the next multiplayer game. In one exemplary embodiment, multiplayer game notice 122 can be implemented as an object having associated data, graphical and functional attributes. Multiplayer game notice 122 is configured to alert users in the gaming room of the next multiplayer game. In one exemplary embodiment, the multiplayer game can operate as an adjunct to standard gaming action, such as by notifying users of a bonus that will be awarded if the user obtains a predetermined number of icons in a single slots game bar. In this example, the users may be awarded additional game credits, an additional number of spins, or other suitable awards if the identified number of icons is displayed after activation of game control 120, in addition to the award that would otherwise be earned. In another exemplary embodiment, multiplayer game notice 122 can allow a user to opt in for a multiplayer game, such as by paying an additional wager, by selecting a user control of multiplayer game notice 122 using a mouse or other pointer device, by touching a corresponding touch screen control associated with multiplayer game notice 122, by using a voice recognition system interface, or in other suitable manners.

Countdown timer 124 displays the time remaining until the next multiplayer game. In one exemplary embodiment, countdown timer 124 can be implemented as an object having associated data, graphical and functional attributes. Countdown timer 124 can generate associated sounds or graphical sequences to alert users of the impending start of a multiplayer game, such as to allow the users to adjust the amount that that is being wagered, to increase or decrease a number of slots game bars being played, to purchase additional game credits, or to otherwise prepare to participate in the multiplayer game.

Winner displays 128 through 134 display players that have won a predetermined prize, such as by matching a predetermined number of icons in a slots game bar. In one exemplary embodiment, winner displays 128 through 134 can be implemented as separate objects having associated data, graphical and functional attributes, as a single object, or in other suitable manners. In another exemplary embodiment, winner displays 128 through 134 can operate in two modes. In the first mode, winner displays 128 through 134 can display users that have won a predetermined prize, such as by matching the maximum number of icons of the same type in a single slots game bar. During a multiplayer game, winner displays 128 through 134 can display the users that have achieved the multiplayer game objective, such as by matching the maximum number of icons of a predetermined type for the multiplayer game. In this exemplary embodiment, the multiplayer game can involve matching five predetermined icons (such as five cats, five diamonds, five ace cards, five cherries or other suitable icons), and when a user achieves the multiplayer game objective, one of winner displays 128 through 134 can be modified to display an image associated with the user, the icon that has been matched, the award associated with the game, or other suitable data.

Player display 136 can include one or more images associated with each of the users participating in the multiplayer slots game for an associated room, such as a profile picture that has been uploaded by each player, an “avatar” or image that is used to represent the player, or other suitable images. In one exemplary embodiment, player display 136 can be implemented as an object having associated data, graphical and functional attributes. In this exemplary embodiment, the multiplayer slots game can be organized into rooms, where the number of players in a single room is limited to a predetermined number. Displaying the image associated with all the players in a given room might consume an inordinate amount of screen space, such that a subset of the current players can be shown instead. Nav control 138 allows a user to navigate through the player images, such as by selecting left and right scroll controls, by searching for a specific player name, or in other suitable manners. In one exemplary embodiment, nav control 138 can be implemented as an object having associated data, graphical and functional attributes.

Chat area 140 allows users to communicate with other each other, such as by entering text into a user entry field. In one exemplary embodiment, chat area 140 can be implemented as an object having associated data, graphical and functional attributes or in other suitable manners.

In operation, user interface 100 allows a user to interact with a multiplayer slots game, such as to play the slots game and to allow the results to be displayed to other users, to participate in multiplayer slots games, to chat with other users, and for other suitable purposes. User interface 100 allows multiple users to participate in slots gaming action, unlike prior art slots games that are intrinsically single player games.

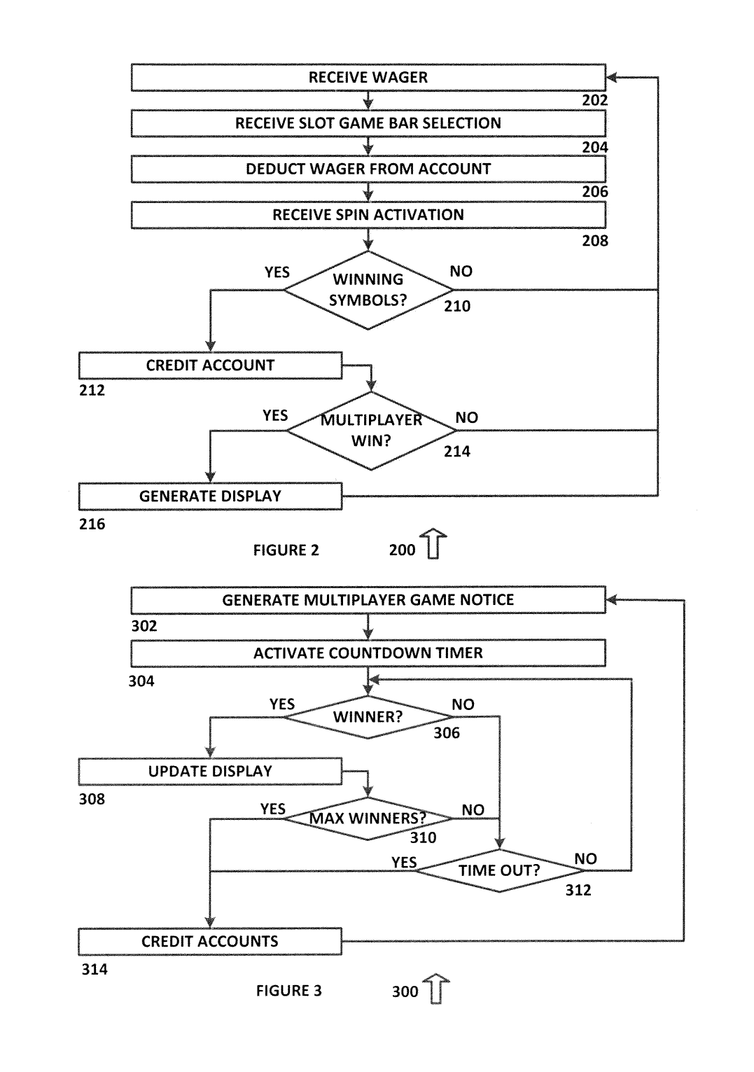

FIG. 2 is a diagram of an algorithm 200 for controlling a multiplayer slots game in accordance with an exemplary embodiment of the present disclosure. Algorithm 200 can be implemented as one or more lines of code operating on one or more general purpose processors, a cellular telephone, a tablet computing device, a suitable combination of devices or in other suitable manners.

Algorithm 200 begins at 202, where a wager is received. In one exemplary embodiment, the wager can be received from an object displayed on a user interface, such as after a user utilizes the object by selecting one or more controls to increase or decrease an amount of the wager and subsequently activates a user control to submit the wager amount. The wager can be received at the user interface device, such as to be transmitted to a central controller, the wager can be received at the central controller, or can be received at other suitable systems. The algorithm then proceeds to 204.

At 204, a slots game bar selection is received. In one exemplary embodiment, the slots game bar selection can be received from an object displayed on a user interface, such as after a user utilizes the object by selecting one or more controls to increase or decrease the number of slots game bars that are to be played and subsequently activates a user control to submit the slots game bar selection. The slots game bar selection can be received at the user interface device, such as to be transmitted to a central controller, the slots game bar selection can be received at the central controller, or can be received at other suitable systems. After the slots game bar selection is received, the number of slots game bars that are displayed on a user interface can be increased or decreased to match the number associated with the slots game bar selection.

In another exemplary embodiment, the user display of slots game bars can be fixed, and the user can select one or more of the slots game bars to play for the next slots game, or other suitable selections can be made. The algorithm then proceeds to 206.

At 206, the amount associated with the wager received at 202 and the slots game bar selection at 204 is deducted from the user's account, such as by multiplying the amount by the number of bars or in other suitable manners. In one exemplary embodiment, the wager can be deducted using a game control object operating at the central controller, the amount of the wager can be compared to an account balance at the user device or at the central controller to determine whether the user has sufficient game credits to place the wager, a notification can be generated if the user does not have sufficient game credits to place the wager, a game credit purchase process can be initiated to allow the user to purchase game credits, or other suitable processes or systems can be used to process the wager. The algorithm then proceeds to 208.

At 208, a spin activation is received and the slots game is activated. In one exemplary embodiment, the spin can be received from an object displayed on a user interface, such as after a user utilizes the object by selecting one or more controls to activate the slots game. The spin activation can be received at the central controller, or can be received at other suitable systems. After the spin activation is received, additional processing can be performed, such as to determine whether a multiplayer game is in progress or for other suitable purposes, and icons are randomly selected for each of the slots game bars associated with the spin. In one exemplary embodiment, a random number can be generated for each of the slots game bars in play, and icons can be selected based on the value of the random number, such as a predetermined number of icons of a certain type. In another exemplary embodiment, the random number can be used to select an award level, and icons can be randomly selected to populate each slots game bar as a function of the award level, or other suitable processes can be used. The algorithm then proceeds to 210.

At 210, it is determined whether the symbols are associated with an award amount. If the symbols are not associated with an award amount, the algorithm returns to 202, otherwise, the algorithm proceeds to 212 where the player's account is credited with the award amount. In one exemplary embodiment, the award amount can be a number of game credits that can be used to purchase additional spin activations, a number of game credits that can be used to place additional wagers, a number of game credits that are used to purchase in-game awards, the award can be collection items, power-ups, or other suitable awards. The algorithm then proceeds to 214.

At 214, it is determined whether a winning multiplayer game condition is associated with the winning symbols, such as where a multiplayer game is in effect and the winning symbols satisfy a condition of the multiplayer game. If it is determined that a multiplayer game win is not associated with the winning symbols, the algorithm returns to 202, otherwise the algorithm proceeds to 216 where a display is generated to indicate that the multiplayer game condition has been satisfied. In addition, an award associated with the multiplayer game can be credited to the user's account and other suitable processes can be performed. The algorithm then returns to 202.

In operation, algorithm 200 allows a user to participate in a multiplayer slots game by selecting a wager, by selecting a number of slots game bars to play, by activating the slots game, by generating associated game displays, and by determining whether an award is associated with the result of the slots game, including a multiplayer award. In this manner, algorithm 200 can be used to control predetermined functions of a multiplayer slots game.

FIG. 3 is a diagram of an algorithm 300 for controlling multiplayer action of a slots game in accordance with an exemplary embodiment of the present disclosure. Algorithm 300 can be implemented as one or more lines of code operating on one or more general purpose processors, a cellular telephone, a tablet computing device, a suitable combination of devices or in other suitable manners.

Algorithm 300 begins at 302, where a multiplayer game notice is generated. In one exemplary embodiment, a central controller can generate a multiplayer game notice, such as after a predetermined length of time has elapsed since the end of a previous multiplayer game. The multiplayer game notice can be selected from one of a plurality of multiplayer games, such as by randomly selecting the multiplayer game, by cycling through a predetermined sequence of multiplayer games, or in other suitable manners. The multiplayer game notice can be transmitted to a plurality of users that are associated with a game room for the multiplayer game, such as where a plurality of game rooms are independently operated for different groups of users. The algorithm then proceeds to 304.

At 304, a countdown timer for the multiplayer game is activated. In one exemplary embodiment, a central controller can activate a countdown timer for the associated multiplayer game, such as after the multiplayer game notice has been generated. The multiplayer game notice can be selected from one of a plurality of multiplayer games, such as by randomly selecting one of a number of multiplayer games, by cycling through a predetermined sequence of multiplayer games, or in other suitable manners. Countdown timer status data can be transmitted to a plurality of users that are associated with a game room for the multiplayer game, such as where a plurality of game rooms are independently operated for different groups of users. The algorithm then proceeds to 306.

At 306, it is determined whether a user has won the multiplayer game. In one exemplary embodiment, the multiplayer game can be implemented by making predetermined award conditions available for a predetermined period of time, such as by awarding a bonus multiplier if the user receives a predetermined combination of randomly selected icons in a slots game bar, such as five icons of a predetermined type. In this exemplary embodiment, the user can be awarded a bonus multiplier of the amount wagered in addition to any usual payout for the selected combination, a predetermined or variable number of game credits, one or more additional “free spins” of the slots game, power-up awards, in-game awards or other suitable awards. If it is determined that no user has won, the algorithm proceeds to 312, otherwise the algorithm proceeds to 308.

At 308, a display on each user interface for users in the room where the multiplayer game is being conducted is updated to reflect the winner. In one exemplary embodiment, data is periodically provided from a multiplayer slots controller to a plurality of user devices, where each user device includes additional local functionality for coordinating with the multiplayer slots controller, such as one or more objects operating in conjunction with a web browser application or other suitable applications. The local functionality receives the periodic data updates from the multiplayer slots controller and updates a user interface, such as a user interface having a timer object, winner display objects and other suitable objects. In this manner, the user interface can be updated to reflect a new winner of the multiplayer game, or in other suitable manners. The algorithm then proceeds to 310.

At 310, it is determined whether a maximum number of winners has been reached. In one exemplary embodiment, a multiplayer slots game can be provided for a predetermined length of time, until a predetermined number of winners have been reached, or in other suitable manners. If it is determined that a maximum number of winners has not been reached, the algorithm proceeds to 310, where it is determined whether a predetermined length of time has elapsed, such as where the multiplayer slots game is provided for a predetermined length of time. If time out has not occurred, the algorithm returns to 306. Otherwise, if time out has occurred, or if the maximum number of winners has been reached, the algorithm proceeds to 314.

At 314, the account of each winner of the multiplayer slots game is credited with the award associated with the multiplayer slots game. In one exemplary embodiment, players can be awarded an additional wager multiplier of the amount wagered for the slots game bar that resulted in the winning icon combination, players can be awarded additional slots game plays (such as where a user requires a first type of credit to activate a round of the game and a second type of credit to place a wager), power-ups, in-game awards or other suitable awards. The algorithm then returns to 302.

In operation, algorithm 300 controls a multiplayer slots game that allows multiple players in a gaming area of an online gaming site to jointly participate in a slots game by individually selecting the amount of game credits or funds to be wagered, the number of slots game bars to play during the multiplayer game, or other game variables. As users win the multiplayer slots game, a display on the user interface of each player in the gaming area can be updated to reflect the identity of the winners. After a predetermined number of users have won, after a predetermined period of time has elapsed, or after other suitable conditions are satisfied, the multiplayer slots game concludes, and another multiplayer game can be scheduled.

FIG. 4 is a diagram of a system 400 for a multiplayer slots gaming environment in accordance with an exemplary embodiment of the present disclosure. System 400 can be implemented in hardware or a suitable combination of hardware and software, and can include a plurality of software systems operating on a plurality of general purpose processors.

System 400 includes multiplayer slots controller 402, slots game controller 404, winning condition monitor 406, award controller 408 and multiplayer slots interfaces 410A through 410N, each of which can be implemented in hardware or a suitable combination of hardware and software. Multiplayer slots controller 402 provides an online multiplayer slots game environment for multiplayer slots interfaces 410A through 410N, such as by interfacing directly with each of multiplayer slots interfaces 410A through 410N through communications media 412, by interfacing with multiplayer slots interfaces 410A through 410N in conjunction with a social network application operating on one or more servers, or in other suitable manners.

Multiplayer slots controller 402 can create and maintain accounts for each user of multiplayer slots interfaces 410A through 410N, can authorize user access to the online slots game, can coordinate communication between users, can allow users to purchase gaming credits, power-ups, in-game awards or other gaming functionality by processing credit card or other payment transactions, can regulate the number of players in a multiplayer environment through the use of rooms and levels, and can perform other suitable multiplayer slots game control functions.

Slots game controller 404 interfaces with multiplayer slots interfaces 410A through 410N to provide individual player functionality. In one exemplary embodiment, slots game controller 404 can generate a random number in response to data from each of multiplayer slots interfaces 410A through 410N that indicates that a slots game has been initiated, such as by activation of spin control 120 of user interface 100 or in other suitable manners, and can provide selected icon arrays associated with a randomly-selected outcome. Slots game controller 404 can also or alternatively coordinate multiplayer slots games, such as by selecting one of a plurality of multiplayer slots games to be offered, by controlling a countdown timer, or in other suitable manners.

Winning condition monitor 406 determines when single or multiplayer slots games have satisfied one or more winning conditions and generates suitable notification data in response. In one exemplary embodiment, winning condition monitor 406 can monitor the results of each slots game bar for each of multiplayer slots interfaces 410A through 410N after a multiplayer slots game has been initiated, such as for each player in a room associated with the multiplayer slots game, and can generate user interface update data to notify participants in the multiplayer slots game of the number of winners, the identity of winners, the amount that has been won, the time remaining in the multiplayer slots game or other suitable information. Winning condition monitor 406 can also monitor the status of a countdown timer and can terminate the multiplayer slots game after the countdown timer has expired, can generate a countdown sequence for the start or end of a multiplayer slots game, and perform other suitable functions.

Award controller 408 controls the award of slots game prizes to users of multiplayer slots interfaces 410A through 410N. In one exemplary embodiment, award controller 408 monitors the results of a multiplayer slots game and provides an award associated with the multiplayer slots game, such as a multiplier that is applied to an amount wagered for the slots game bar on which a series of winning icons was displayed. In this exemplary embodiment, a player can adjust the amount of a wager for each slots game bar during the multiplayer slots game, and can win multiple awards during the course of the multiplayer slots game, such that award controller 408 applies the wager in effect at the time each award was won to the multiplier. In another exemplary embodiment, award controller 408 can select one or more awards for a regular or multiplayer slots game, such as a predetermined number of game credits, a multiplier that is applied to a wagered amount, power-up awards, in-game awards, collection items, additional slots game plays or other suitable awards.

Multiplayer slots interfaces 410A through 410N allow a plurality of users to interface with multiplayer slots controller 402 through communications medium 412, where N is a positive, non-zero integer that represents the number of players. In one exemplary embodiment, multiplayer slots interfaces 410A through 410N can each receive one or more objects that operate in conjunction with a web browser or other application and that generate display data and receive user-selected control data to allow users to interface with multiplayer slots game controller 402.

In operation, system 400 allows users to interface with an online multiplayer slots game to play slots in a multiplayer environment. System 400 allows users to independently control an amount wagered for each simulated pull of a slot machine handle, to select the number of bars of a simulated slot machine that will be played, and to receive awards for winning combinations of icons on one of more bars. System 400 also allows users to participate in a multiplayer slots game where one or more predetermined awards are provided to users that meet predetermined criteria, such as a predetermined arrangement of icons, a total number of points awarded, or other suitable multiplayer games.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A multiplayer slots game system comprising:
a multiplayer slots game controller operating on a processor;
a plurality of multiplayer slots interfaces, each operating on an associated processor and coupled to the multiplayer slots game controller through a communications medium; and
a plurality of user interfaces operating on each of the multiplayer slots interfaces, each of the plurality of user interfaces generating a user display that includes two or more user identifiers.

2. The multiplayer slots game system of claim 1 further comprising a slots game controller coupled to each of the plurality of multiplayer slots interfaces, the slots game controller configured to receive slots game bar activation data from each of the multiplayer slots interfaces and to generate slots game results data in response to the slots game bar activation data.

3. The multiplayer slots game system of claim 1 further comprising a winning condition monitor configured to receive slots game results data associated with two or more multiplayer slots interfaces and to generate multiplayer slots game results data in response.

4. The multiplayer slots game system of claim 1 further comprising an award controller configured to receive wager data from two or more multiplayer slots interfaces and slots game results data associated with the two or more multiplayer slots interfaces and to generate slots game award data in response.

5. The multiplayer slots game system of claim 1 wherein the user interfaces each include one or more multiplayer game notice objects.

6. The multiplayer slots game system of claim 1 wherein the user interfaces each include one or more countdown timer objects.

7. A user interface for a multiplayer slots game comprising:
one or more slots bar displays configured to display a sequence of icons;
a slots bar display selection control configured to receive a user entry of a number of slots bar displays from a first user and to transmit the user entry to a game controller; and
a multiple user display configured to display one or more other users that are participating in the multiplayer slots game.

8. The user interface of claim 7 wherein the slots bar display selection control comprises an object having associated data, graphical and functional attributes.

9. The user interface of claim 7 further comprising a multiplayer slots game countdown timer configured to generate a countdown sequence for indicating a time until a start of the multiplayer slots game.

10. The user interface of claim 7 further comprising a winner display configured to receive winner data from the game controller and to generate image data associated with the received winner data.

11. the user interface of claim 7 further comprising a navigation control configured to receive user commands to control a display of the other users that are participating in the multiplayer slots game.

12. A method for controlling a multiplayer slots game comprising:
generating a notice on a plurality of user displays of a scheduled multiplayer slots game using a processor;
generating a countdown timer on the plurality of user displays of the time remaining until a start of the scheduled multiplayer slots game using the processor;
tracking gaming activity of a plurality of users of the scheduled multiplayer slots game after the start of the scheduled multiplayer slots game to identify a first winner using the processor; and
generating a notification on the plurality of user displays of the first winner using the processor.

13. The method of claim 12 further comprising:
tracking the gaming activity of the plurality of users of the scheduled multiplayer slots game after the start of the scheduled multiplayer slots game to identify a second winner; and
generating a notification on the plurality of user displays of the second winner.

14. The method of claim 12 further comprising:
determining whether a predetermined number of winners has been reached; and
generating an end of game notification on the plurality of user displays after the predetermined number of winners has been reached.

15. The method of claim 12 wherein tracking the gaming activity of the plurality of users of the scheduled multiplayer slots game after the start of the scheduled multiplayer slots game to identify the first winner using the processor further comprises determining whether a predetermined series of icons has been generated for display on a game bar display of one of the plurality of user displays.

16. The method of claim 12 further comprising generating a countdown timer on the plurality of user displays of the time remaining until an end of the scheduled multiplayer slots game.

17. The method of claim 12 further comprising:
determining whether a predetermined number of winners has been reached; and
determining whether a countdown timer for an end of the multiplayer slots game has expired if the predetermined number of winners has not been reached; and
generating an end of game notification on the plurality of user displays after the predetermined number of winners has been reached or the countdown timer for the end of the multiplayer slots game has expired.

18. The method of claim 12 further comprising:
receiving a user selection from a user of a number of slots game bars to be played; and
generating the number of slots game bars on the user display associated with the user.
